(19) United States
(12) Patent Application Publication
(10) Pub. No.: US 2003/0154113 A1
(43) Pub. Date: Aug. 14, 2003

(54) System and method for scheduling outsourced production

(76) Inventors: Chien-Chih Chen, Tu-Chen (TW); Changbo Cheng, Kunsan (CN); DongHua Tang, Shenzhen (CN); Xudong Wan, Shenzhen (CN); Lizong Xu, Shenzhen (CN); YaoZhang Wei, Shenzhen (CN)

Correspondence Address: Wei Te (Joseph) Chung, Foxconn International, Inc., 1650 Memorex Drive, Santa Clara, CA, 95050, US

(21) Appl. No.: 10/077,622

(22) Filed: Feb. 14, 2002

(51) Int. Cl. G06F 17/60

(52) U.S. Cl. 705/7

(57) ABSTRACT

A system and method for scheduling outsourced production is provided. The system includes an order generating module (111), a consignee assigning module (121), a consignee operating module (131), a data processing module (112) and an order canceling module (113). When there is a demand for outsourcing, the order generating module (111) generates a consignment order. Then the consignee assigning module (121), according to the content of the consignment order, determines a consignee. After the consignment order is fulfilled, the data processing module (112) guides a consignor to inspect the products based on the consignment order. If the consignment order is decided to be canceled, the order canceling module (113) can do so before a consignee is assigned.

### FIELD OF THE INVENTION

The present invention relates to a system and method for scheduling outsourced production, more particularly, to a system and method for consigning orders to other production departments or factories when the manufacturer is in scarcity of production capacity.

### BACKGROUND OF THE INVENTION

Usually there are many small production departments in a large enterprise. Among them, some have a large number of original orders beyond their production capacity, while others might have surplus production capacity. In the circumstances, the former will consign some orders to the latter to fulfill. Additionally, some products needing to be handled by very special processes may also require outsourcing. This situation occurs when the production department receiving the special order is not familiar with the very special process for fulfilling the order.

When receiving original orders, most manufacturers may not have the ability to produce all the ordered products by themselves. Some of them outsource to other manufacturers. Particularly, some manufacturers may produce nothing on the orders, but outsource to other manufacturers.

Traditionally, outsourcing is performed through communication means such as telephone and fax. Those conventional means can't transmit information on a real-time basis and influence the timeliness of production. U.S. Pat. No. 6,044,356 discloses an assistant for resource and demand trading. The assistant can generate an optimal solution to allocate sources of resource information to demand information by the use of a solution generator. However, the system doesn't disclose the detailed procedure as to how to meet demand information after generating a solution. Accordingly, what is needed is a system and method that can integrate all parties' information to finally meet demand.

### SUMMARY OF THE INVENTION

The major object of the present invention is to provide a system and method for scheduling outsourced production, enabling a production department to consign its orders to others when it lacks production capacity or special processes needed for production.

Another object of the present invention is to provide a system and method for scheduling outsourced production, enabling a consignor to cancel consigned orders on line, inspect and accept or reject products on line.

In order to achieve the above objects, the present invention provides a system and method for scheduling outsourced production. The system comprises: an order generating module which generates a consignment order and transmits it to a consignee assigning module; a consignee assigning module which assigns a consignee to complete the consignment order; a consignee operating module which receives and confirms the consignment order, and sends a work-done notice upon fulfilling the consignment order; a data processing module which deals with the information in association with the consignment order, including inspection data, rejection data, consignment order's status; an order canceling module which cancels the consignment order before the consignee assigning module assigns a consignee.

Also, the present invention provides a system and method for scheduling outsourced production. The method comprises steps of: checking in a consignor's computer the consignor's present available capacity and processes and required capacity and processes for fulfilling an original order; deciding which part of the original order needing outsourcing based on the checking; generating and transmitting a consignment order based on the decided outsourcing part to a management computer; receiving the consignment order in the management computer, assigning corresponding consignee according to the consignment order, and forwarding the consignment order to the consignee. After receiving the consignment order, a consignee's computer confirms the consignment order, and transmits a work-done notice to the consignor's computer after the order is fulfilled. After receiving the products, the consignor's computer guides the consignor to inspect the products, generates inspection data, rejection data, and updates consignment order processing data. In addition, the method comprises a step to cancel the consignment order, which should be performed before the management computer assigns a consignee.

### BRIEF DESCRIPTION OF THE DRAWINGS

FIG. 1 is a schematic diagram of the framework of a system for scheduling outsourced production according to a preferred embodiment of the present invention;

FIG. 2 is a data flowchart of the system shown in FIG. 1;

FIG. 3 is a flowchart for generating a consignment order by an order generating module in a consignor's computer;

FIG. 4 is a flowchart for assigning a consignee to fulfill the consignment order by a consignee assigning module in a management computer; and

FIG. 5 is an operation flowchart of the system shown in FIG. 1.

### DETAILED DESCRIPTION OF THE PREFERRED EMBODIMENT

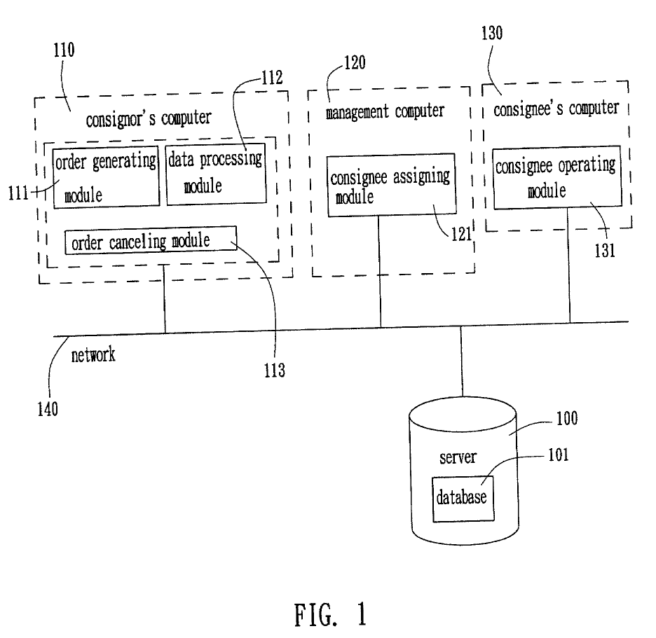

FIG. 1 is a schematic diagram of the framework of the system for scheduling outsourced production. The system comprises a server 100, a consignor's computer 110, a management computer 120, and a consignee's computer 130. In the preferred embodiment of the present invention, a consignor may be a factory, or a small production department in a factory, which has to place one or more consignment orders to another internal production departments or external factories because of the scarcity of production capacity or special processes needed for fulfilling the consignment order. The next is to arrange a consignee according to the consignment orders. The consignee is an independent production department or factory.

The consignor's computer 110 comprises an order generating module 111 for generating consignment orders according to the original orders and transmitting the consignment orders to the management computer 120, a data processing module 112 for dealing with the data in association with the consignment orders, an order canceling module 113 enabling the consignor to cancel the consignment order before the management computer 120 assigns a consignee. A consignee assigning module 121 is installed in the management computer 120 for assigning a consignee according to the consignment orders, transmitting the consignment orders and other corresponding information to the consignee, and transmitting the consignment order to the data processing module after receiving the consignee's confirmation. A consignee operating module 131 is installed in the consignee's computer 130 for receiving and confirming the consignment orders sent from the consignee assigning module 121, and sending a work-done notice to the consignor after completing the consignment orders, A database 101 is installed in the server 100 for storing all kinds of data generated during the assigning process.

All information generated in the consignor's computer 110, the management computer 120 and the consignee's computer 130 is transmitted and stored in the database 101 of the server 100 via a network 140, which connects the server 100 with the consignor's computer 110, the management computer 120 and the consignee's computer 130. The network 140 may be the Internet, an intranet or combination of the two.

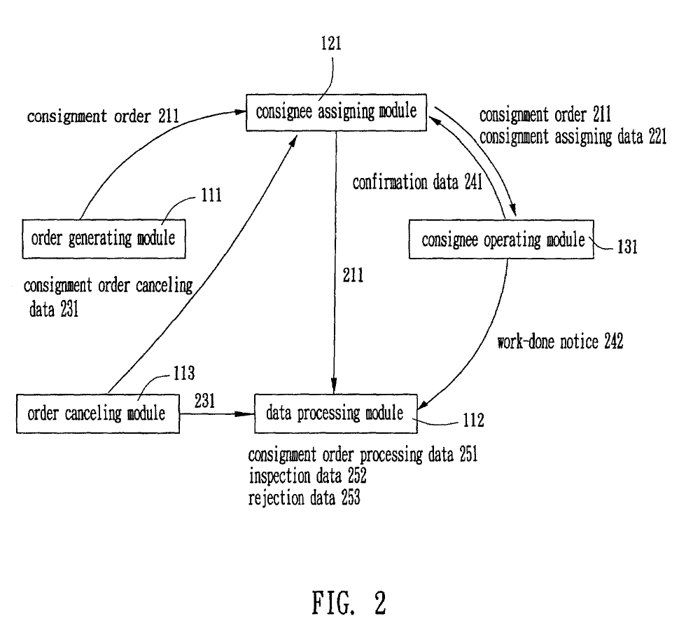

FIG. 2 is a data flowchart of the system shown in FIG. 1. The order generating module 111 is provided for generating consignment orders 211, which comprises such information as consignment price, deadline of the consignment order, and other production requirements. After generating the consignment order 211, the order generating module 111 sends it to the consignee assigning module 121 in the management computer 120 to assign consignees.

The consignee assigning module 121 receives the consignment order 211, generates consignment assigning data 221, and sends the consignment order 211 and the consignment assigning data 221 to the consignee operating module 131, wherein the consignment assigning data 221 comprises such data as the name, address, contact information of the consignee, and the order number. After receiving the consignee's confirmation, the consignee assigning module 121 also sends the consignment order 211 to the data processing module 112.

The order canceling module 113 is provided for generating consignment order canceling data 231, wherein the consignment order canceling data 231 indicate the reasons for and the time of canceling the consignment order. The consignment order canceling data 231 are transmitted to the consignee assigning module 121, and also transmitted to the data processing module 112.

The consignee operating module 131 receives and confirms the consignment order 211 and finally generates a work-done notice 242 after fulfilling the consignment order 211. After receiving the consignment order 211, the consignee operating module 131 confirms it and sends confirmation data 241 to the consignee assigning module 121. Next, the consignee operating module 131 schedules production according to the requirements of the consignment order 211, and after fulfilling the consignment order, generates and sends the corresponding work-done notice 242 to the data processing module 112.

The data processing module 112 generates consignment order processing data 251, inspection data 252 and rejection data 253. The consignment order processing data 251 indicates that the status of the consignment order is either one of ‘cancelled’, ‘work-in-process (consigned)’, ‘work-done’ and ‘rejected’. The inspection data 252 indicates the volume of each qualified product. The rejection data 253 indicates the volume of each unqualified products.

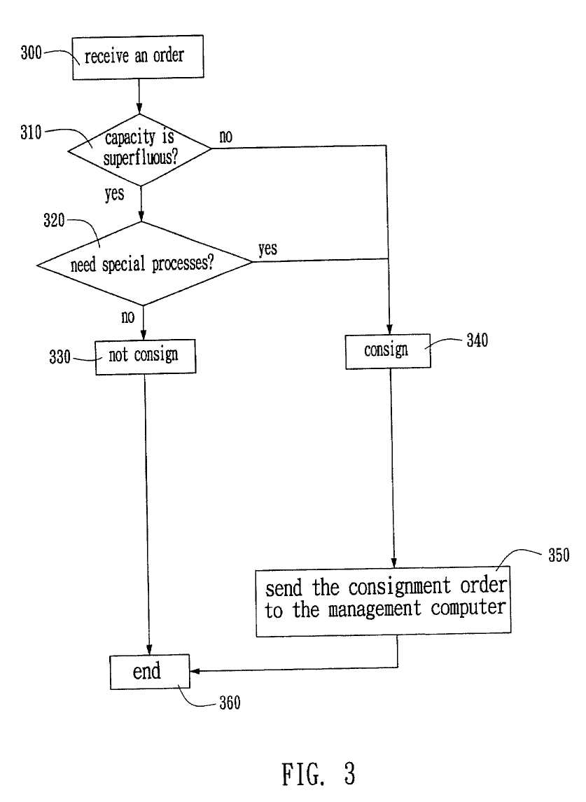

FIG. 3 is a flowchart for generating consignment orders. In step 300, the production department receives an order. In step 310, the order generating module checks consignor's production capacity to see whether the consignor is able to complete the original order before deadline. If there isn't enough production capacity, in step 340, an outsourcing is decided and a consignment order is generated. On the contrary, if the production department has enough production capacity to fulfill the original order, in step 320, the order generating module 111 decides whether there are any special processes needed which the consignor is not capable of for fulfilling the original order. If positive, in step 340, the order generating module 111 sets all or part of products of the original order for outsourcing, and generates a consignment order. Otherwise, in step 330, the order generating module 111 decides that the order needs no consignment, then in step 360 the whole procedure is over.

After generating the consignment order, in step 350, the order generating module 111 sends it to the management computer 120 in which an assignment of consignees is recorded. After step 350, the whole procedure of generating consignment orders is over in step 360.

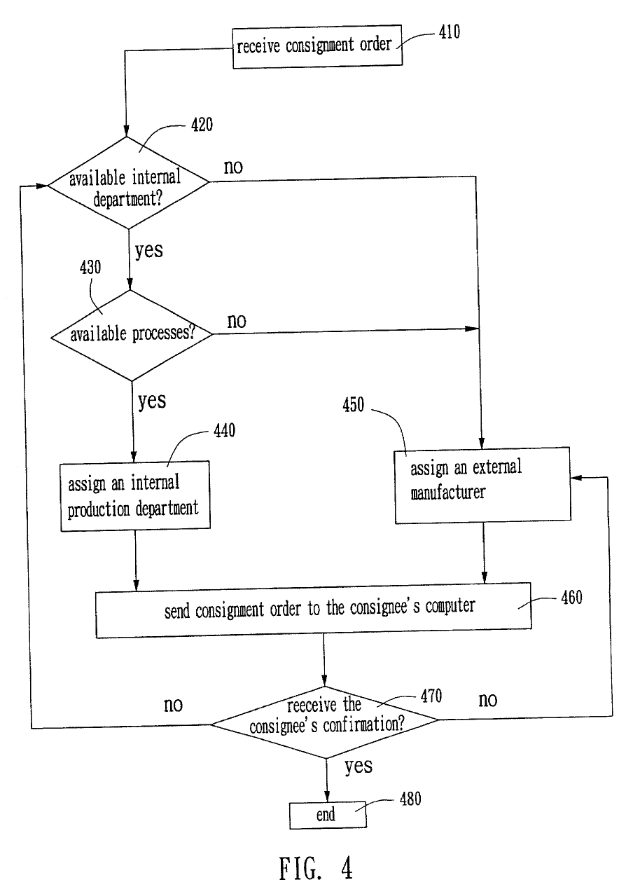

FIG. 4 is a flowchart for assigning a consignee when a production department requires outsourcing. In step 410, the consignee assigning module 121 (see FIG. 1) in the management computer 120 receives the consignment order from the order generating module 111. In step 420, the consignee assigning module 121 checks from the database 101 the production capacities of other production departments of the same company with the consignor to see if there are internal production departments available to fulfill the consignment order. If none of the internal production departments are available, in step 450, the consignee assigning module 121 assigns the consignment order to an external manufacturer. If there is an internal production department available to fulfill the consignment order, in step 430, the consignee assigning module 121 checks the database 101 to see whether the production department is capable of the processes required by the consignment order. If the production department isn't capable of the processes, the routine also proceeds to step 450 in which the consignee assigning module 121 checks the capacities and processes of external manufacturers stored in the database 101 beforehand, and assigns the consignment order to an external manufacturer that is available in both the capacities and the processes. In step 440, if a production department is available of both superfluous capacity and required processes, the consignee assigning module 121 selects the production department to be the consignee.

After assigning the consignee, in step 460, the consignee assigning module 121 sends consignment order 211 and consignment assigning data 221 to the corresponding consignee's computer 130, and also sends consignment order 211 to the consignor's computer 110 after receiving confirmation (not shown in FIG. 4). In step 470, the consignee assigning module 121 decides whether to receive an confirmation. If positive, in step 480, the management computer 120 finishes the whole procedure of assigning a consignee. If negative, the routine proceeds to step 420 if the first assigned consignee is an internal production department, or proceeds to step 450 if the first assigned consignee is an external manufacturer.

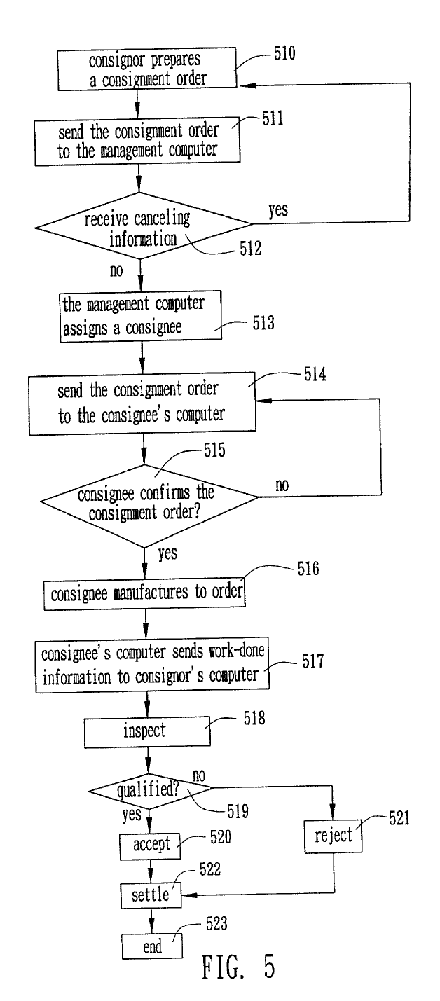

FIG. 5 is an operation flowchart of the system shown in FIG. 1. First of all, upon receiving an order, the order generating module 111 in the consignor's computer 110 assesses whether the consignor could fulfill the order on time considering its present capacity and capability of processes. If the required capacity or processes are not available, in step 510, the order generating module 111 prepares a consignment order, and in step 511, transmits it to the management computer 120.

When the consignment order is sent to the management computer 120 while not yet assigned to a consignee by the consignee assigning module 121, the consignor may want to cancel the consignment because of unexpected superfluous capacity or other reasons. In this situation, the order canceling module 113 sends consignment order canceling data 231 to the consignee assigning module 121. Before assigning a consignee, in step 512, consignee assigning module 121 checks whether the consignment order canceling data 231 is received. If the order canceling data 231 are received, then in step 524, the whole procedure is over. Contrarily, if receiving the order canceling data 231 are not received, in step 513, the consignee assigning module 121 checks from the database 101 capacities and processes of other production departments and manufactures and selects a consignee according to the order's requirements. After assigning the consignee, in step 514, the consignee assigning module 121 sends the assignment information to the consignor's computer 110 and the assigned consignee's computer 130.

After receiving the consignment order, in step 515, the consignee decides whether to accept it or not. If negative, the routine goes back to step 514. If positive, in step 516, the consignee begins to manufacture according to the requirement of the consignment order. After products are finished, in step 517, the consignee operating module 131 transmits work-done data 242 to the consignor's computer 110.

In step 518, on receiving work-done notice 242, the data processing module 112 guides the consignor to inspect the products. In step 519, the data processing module 112 decides whether the products are qualified based on requirement of the consignment order. If the products are qualified, in step 520, the data processing module 112 generates inspection data 252 indicating the amount of qualified products, and updates the consignment order processing data 251 from “work-in-process” to “work-done.” If the products are unqualified, in step 521, data processing module 112 generates the rejection data 253 indicating the amount of unqualified products, and updates the consignment order processing data 251 as rejected. After inspection, in step 522, the consignor settles with the consignee. Thus, in step 523, the whole procedure of outsourcing is ended.

Although the present invention has been described in terms of the above embodiment, it is not intended that the invention be limited to that embodiment. Modification within the spirit of the invention will be apparent to those skilled in the art. And the scope of the present invention is defined by the following claims.

We claim:

1. A system for scheduling outsourced production, comprising:
an order generating module for generating a consignment order;
a consignee assigning module for receiving the consignment order generated by the order generating module, and assigning a consignee to fulfill the consignment order;
a consignee operating module for receiving and confirming the consignment order and sending work-done information of the consignment order to a data processing module; and
a data processing module for generating consignment order processing data and processing the inspection of the work-done consignment order.

2. The system of claim 1 further including an order canceling module which is for the consignor to cancel the consignment order before a consignee is assigned.

3. The system of claim 1 further including a database for storing the data generated by the order generating module, the consignee assigning module, the consignee operating module, the data processing module and the order canceling module during the scheduling process, and storing available capacities and processes of a consignor and possible consignees.

4. The system of claim 1, wherein consignment order processing data generated by the data processing module is the consignment order's status including ‘canceled’, ‘work-in-process’, ‘work-done’ and ‘rejected’.

5. A method for scheduling outsourced production, comprising:
receiving an original order and storing the original order in a database by an order generating module;
generating a consignment order according to the original order and available capacity and processes of a consignor by the order generating module; and
assigning a consignee by a consignee assigning module.

6. The method of claim 5, wherein generating a consignment order includes checking the original order against a consignor's own available capacity and processes.

7. The method of claim 5, wherein generating a consignment order further includes sending the consignment order to the consignee assigning module.

8. The method of claim 7, wherein sending the consignment order to the consignee assigning module is to store the consignment order in the database and at the same time send a notification to the consignee assigning module.

9. The method of claim 5 further including the step of canceling a consignment order, which should be performed before the consignee assigning module assigns a consignee.

10. The method of claim 5, wherein assigning a consignee includes checking the consignment order against capacities and processes of other production departments whose data are stored in the database in advance.

11. The method of claim 10, wherein other production departments includes internal production departments and external manufacturers.

12. The method of claim 5, wherein assigning a consignee further includes sending the consignment order to the consignee's computer.

13. The method of claim 12, wherein sending the consignment order to the consignee's computer is to store the consignment order in the database and at the same time notify the consignee operating module.

14. The method of claim 5 further includes the consignee's computer receives and confirms the consignment order, and sends the work-done consignment order to the data processing module.

15. A process of handling an order for a division of a company, comprising the steps of:
A. receiving the order;
B. checking if capacity is superfluous in said division;
C. issuing a consignment order if no, or further checking if special processes are required and can not be handled by said division if yes;
D. issuing the consignment order if special processes are required, or not issuing the consignment order and ending this process if no said special processes are required;
E. checking if any internal department in the same company can fulfill capacity of the consignment order;
F. assigning an external manufacturer and sending consignment order to a consignee's computer if no, or further checking whether qualified internal departments own capability of implementing the required special processes if yes;
G. assigning the internal department and sending consignment order to the consignee's computer if said internal department owns said capability of implementing the required special processes, or assigning the external manufacturer and sending consignment order to the consignee's computer if said internal department does not.

16. The process of claim 15, wherein after sending consignment order to the consignee's computer, further comprising a step of receipt of consignee's confirmation, and if yes, ending the processes, or if no, being back to the step E if the consignee is the internal department or to the step G for looking for another external manufacturer if the consignee is the external manufacturer.
